(19) United States
(12) Patent Application Publication
(10) Pub. No.: US 2010/0045214 A1
(43) Pub. Date: Feb. 25, 2010

(54) SHAPE MEMORY ALLOY ACTUATOR SYSTEM

(75) Inventor: Kaoru Matsuki, Kanagawa (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/543,037

(22) Filed: Aug. 18, 2009

(30) Foreign Application Priority Data
Aug. 20, 2008 (JP) 2008-211457

(51) Int. Cl. H02N 10/00

(52) U.S. Cl. 318/117; 310/306

(57) ABSTRACT

A resistance feedback circuit has a detecting section which detects a resistance of a shape memory alloy wire at the time of contraction and elongation, a calculating section which compares an output signal acquired from the detecting section and a signal input by a command section, and calculates an applied electric current corresponding to the resistance value detected, an output section which outputs the applied electric current which is output from the calculating section, to the shape memory alloy actuator, a control section which controls the detecting section, the calculating section and the output section, a storage section which stores a maximum value and a minimum value of the resistance which is measured in advance, and a command correcting section which corrects a signal output from the command section, based on the resistance value stored in the storage section, and a command signal which is output from the command correcting section is set to a resistance value which is higher than the minimum resistance value by a correction value.

### CROSS-REFERENCE TO RELATED APPLICATION

The present application is based upon and claims the benefit of priority from the prior Japanese Patent Application No. 2008-211457 filed on Aug. 20, 2008; the entire contents of which are incorporated herein by reference.

### BACKGROUND OF THE INVENTION

1. Field of the Invention

The present invention relates to a shape memory alloy actuator system.

2. Description of the Related Art

In a shape memory alloy, a shape of the shape memory alloy is changed by passing an electric power, and by controlling universally an expansion and a contraction of the shape memory alloy while detecting a value of an electrical resistance which changes with the change in the shape of the shape memory alloy, it is possible to control a degree of expansion and contraction of the shape memory alloy. Therefore, the shape memory alloy has a characteristic which is extremely suitable for small-sizing of an apparatus.

However, when a shape memory alloy is heated excessively, characteristics as a shape memory alloy cease to be exerted favorably. Even from a view point of a product life, a safety aspect, and electric power consumption, such excessive heating of a shape memory alloy is not preferable. Moreover, measures for carrying out an optimum control of a shape memory alloy according to an operational environment and a secular change are necessary.

As a conventional actuator in which, a shape memory alloy is used, an actuator described in Japanese Patent Application Laid-open Publication No. 2006-183564 is available. This actuator will be described below by referring to FIG. 8, FIG. 9, and FIG. 10. The actuator shown in FIG. 8 includes a power supply control circuit 600 and a wire control circuit 650. The power supply control circuit 600, as shown in FIG. 9, includes a state detecting section 610, an operating section 620, an instruction detecting section 630, and a control section 640. Furthermore, the operating section 620, as shown in FIG. 10, includes a time specifying section 622, an operation power supply section 624, a limit judging section 626, and a limit control section 628. Here, FIG. 8 is a diagram showing a circuit structure of the conventional actuator. FIG. 9 is a block diagram showing a structure of the power supply control unit 600 of the actuator shown in FIG. 8. FIG. 10 is a block diagram showing a structure of the operating section 620 shown in FIG. 9.

In this actuator, when the power supply control unit 600 puts a first transistor Tr1 ON, an electric power is supplied to a first resistance R1, a wire 700, a second resistance R2, and a third resistance R3. At this time, a difference in an electric potential V1 between points connecting the wire 700 and the first resistance R1 and an electric potential V3 between points connecting the second resistance R2 and the third resistance R3 is amplified by a differential amplifier 660. The power supply control unit 600 controls an expansion and a contraction of the wire 700 based on a difference value amplified by the differential amplifier 660. Since it is possible to control a length of the wire 700 having a resistance without installing a position sensor at an exterior, it is possible to make small a size of the actuator.

However, in this actuator, an amount of displacement of the wire 700 is not being observed. In spite of this, when an attempt is made to carry out a control even when the actuator is in a state of not being capable of moving, by a regulating member, the performance is deteriorated by heating the wire 700 excessively.

At this time, for preventing the excessive heating of the wire 700, the power supply control unit 600 carries out a judgment of a limit condition which is determined in advance by acquiring at the time of control, and when the limit condition is satisfied, controls the power supply to the wire 700. The limit judgment in the conventional example described above includes a case in which, the resistance value does not change for a fixed time, and a case in which an amount of electric power supplied crosses a limit value in a fixed time. In a case of control ling the amount of power supply when the limit has been crossed, since a shape memory alloy may be cooled excessively when the amount of power supply is controlled after the limit condition has been judged, there is a deformation and a shape cannot be maintained, thereby making it impossible to hold a position of the actuator.

### SUMMARY OF THE INVENTION

The present invention is made in view of the abovementioned circumstances, for making it possible to prevent an excessive heating of a shape memory alloy wire in a shape memory alloy actuator system in which a moving distance of a mobile object is determined in advance by a regulating member. Concretely, an object of the present invention is to acquire a resistance value in a range of movement which is determined by the regulating member before carrying out a resistance control, and to calculate and store a resistance value which can be commanded based on the resistance value acquired, and not let any other value to be commanded.

To solve the abovementioned issues and to achieve the object, according to the present invention, there can be provided a shape memory alloy actuator system including

a shape memory alloy actuator in which, a range of movement of a mobile object attached to a shape memory alloy actuator of which, a length elongates and contracts by a change in a temperature, is determined by a regulating member, and

a resistance feedback circuit which has a detecting section which detects a resistance of the shape memory alloy wire when the shape memory alloy actuator contracts and expands, a calculating section which compares an output signal acquired from the detecting section and a signal input by a command section, and calculates an applied electric current corresponding to the resistance value detected, an output section which outputs the applied electric current which is output from the calculating section, to the shape memory alloy actuator, a control section which controls at least the detecting section, the calculating section, and the output section, a storage section which stores a maximum value and a minimum value of the resistance which is measured in advance, and a command correcting section which corrects a signal output from the command section, based on the resistance value stored in the storage section, and

a command signal which is output from the command correcting section is set to a resistance value which is higher than the minimum resistance value by a correction value.

In the shape memory alloy actuator system according to the present invention, it is preferable that the correction value is higher than a detected-noise value.

In the shape memory alloy actuator system according to the present invention, it is preferable that the maximum resistance value and the minimum resistance value are acquired when the power supply is put ON.

In the shape memory alloy actuator system according to the present invention, it is preferable that the maximum resistance value and the minimum resistance value are acquired upon elapsing of a predetermined time.

### BRIEF DESCRIPTION OF THE DRAWINGS

FIG. 1 is a block diagram showing a system of a shape memory alloy actuator according to an embodiment of the present invention;

FIG. 2 is a diagram showing a schematic structure of the shape memory alloy actuator, as well as an extended state of a shape memory alloy wire;

FIG. 3 is a diagram showing a schematic structure of the shape memory alloy actuator, as well as is a diagram showing a state in which the shape memory alloy wire is contracted upon being heated, and also being controlled by using a resistance feedback circuit;

FIG. 4 is a graph showing a relationship of a range of movement of a mobile object and a resistance value of the shape memory alloy wire;

FIG. 5 is a graph showing a relationship of a control target resistance value of the shape memory alloy wire and a position of the mobile object;

FIG. 6 is a flowchart showing a flow in a case of carrying out a calibration and a correction value calculation at the time of putting ON a power supply of the shape memory alloy actuator system, or in other words, before start of a control;

FIG. 7 is a flowchart showing a flow in a case of carrying out the calibration and the correction value calculation at a predetermined time interval, after the power supply of the shape memory alloy actuator is put ON, or in other words, after start of the control;

FIG. 8 is a diagram showing a circuit structure of a conventional actuator;

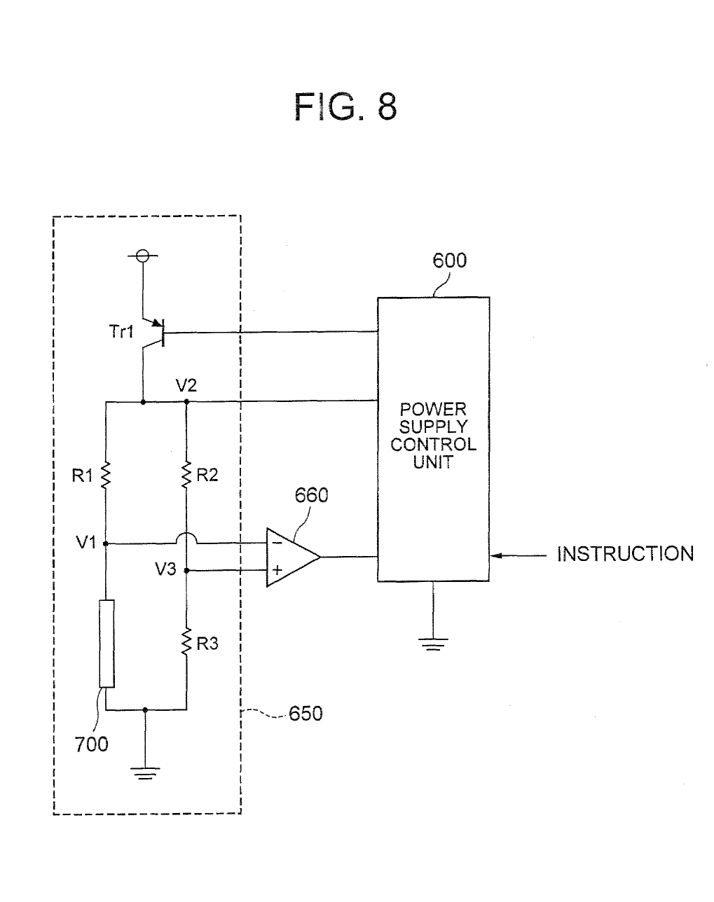

FIG. 9 is a block diagram showing a structure of a power supply control unit of the actuator shown in FIG. 8; and

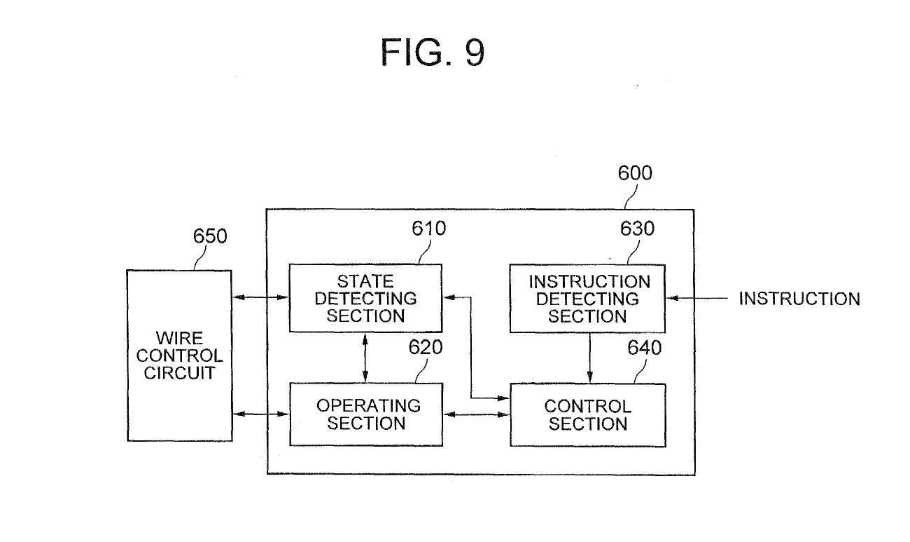

FIG. 10 is a block diagram showing a structure of an operating section shown in FIG. 9.

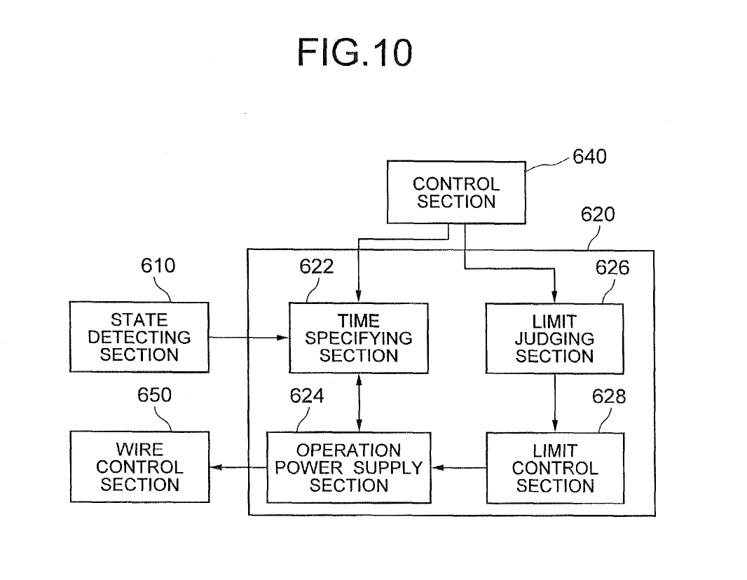

### DETAILED DESCRIPTION OF THE INVENTION

An embodiment of a shape memory alloy actuator system according to the present invention will be described below in detail by referring to the accompanying diagrams. However, the present invention is not restricted by the embodiment described below.

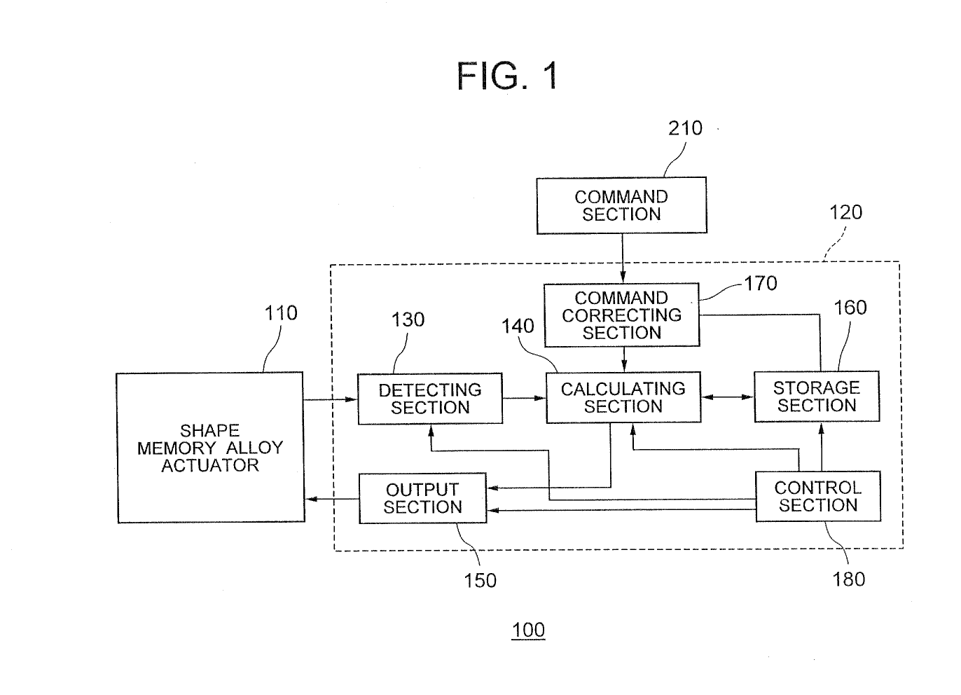

FIG. 1 is a block diagram showing a structure of a shape memory alloy actuator system 100 according to the embodiment of the present invention. As shown in FIG. 1, the shape memory alloy actuator system 100 includes a shape memory alloy actuator 110 and a resistance feedback circuit 120.

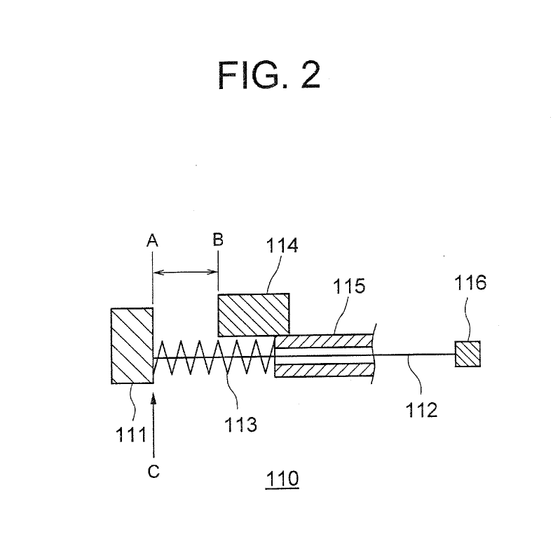

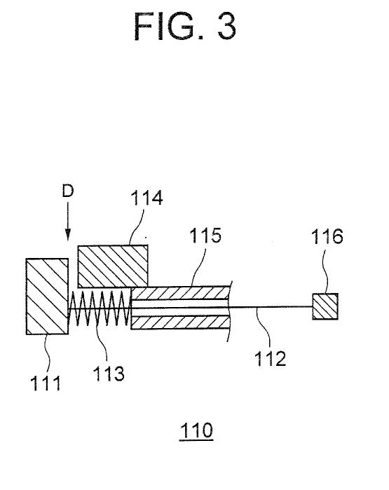

FIG. 2 is a diagram showing a schematic structure of the shape memory alloy actuator 110, as well as an extended state of a shape memory alloy wire 112. FIG. 3 is a diagram showing a schematic structure of the shape memory alloy actuator 110, as well as is a diagram showing a state in which the shape memory alloy wire 112 is contracted upon being heated, and also being controlled by using the resistance feedback circuit 120.

The shape memory alloy actuator 110, a shown in FIG. 2 and FIG. 3, includes a mobile object 111, the shape memory alloy wire 112 of which, one end is connected to the mobile object 111, a fixed end 116 to which, the other end of the shape memory alloy wire 112 is connected, a cylindrical-shaped member 115 having the shape memory alloy wire 112 inserted therein, a bias spring 113 provided with an elastic force which separates the mobile object 111 and the cylindrical-shaped member 115, and a regulating member 114 which regulates a range of movement of the mobile object 111 when the shape memory alloy wire 112 moves. In this shape memory alloy actuator 110, the range of movement of the mobile object 111 which is attached to the shape memory alloy wire 112 of which, a length extends and contracts due to a change in a temperature, is determined by the regulating member 114.

The resistance feedback circuit 120 includes a detecting section 130, a calculating section 140, an output section 150, a storage section 160, a command correcting section 170, and a control section 180.

The detecting section 130 detects a resistance which changes according to a change in the length due to the contraction and the extension of the shape memory alloy wire 112. The calculating section 140 calculates an electric current value for controlling by calculating a difference between a resistance value as an output signal which is acquired by the detecting section 130, and a resistance value which is input from a command section 210 outside the resistance feedback circuit 120. The output section 150 applies the electric current value calculated by the calculating section 140 to the shape memory alloy actuator 110. The maximum resistance value and the minimum resistance value obtained by calibration carried out in advance are stored in the storage section 160. The command correcting section 170 corrects a signal input from the command section 190 by multiplying the maximum resistance value and the minimum resistance value stored in the storage section 160, by a set value input from the command correcting section 170. Moreover, the detecting section 130, the calculating section 140, and the output section 150 are controlled by the control section 180.

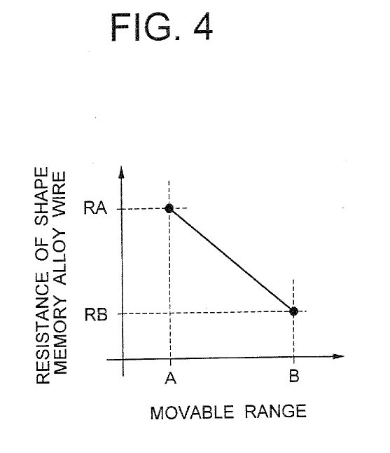

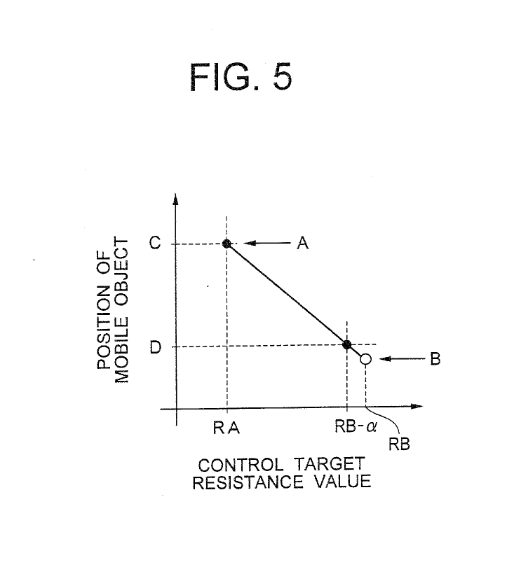

Next, an operation of the shape memory alloy actuator system 100 according to the embodiment will be described by using FIG. 2, FIG. 3, FIG. 4, and FIG. 5. FIG. 4 is a graph showing a relationship of the range of movement of the mobile object 111 and the resistance value of the shape memory alloy wire 112. FIG. 5 is a graph showing a relationship of a control target resistance value of the shape memory alloy wire 112 and a position of the mobile object 111.

When the shape memory alloy wire 112 is heated by supplying an electric power, the shape memory alloy wire 112 contracts in a rightward direction of a paper surface of FIG. 2 and FIG. 3, with the fixed member 116 as a reference. As the shape memory alloy wire 112 contracts, the mobile object 111 which has been at a position A (FIG. 2) before the shape memory alloy wire 112 is heated by supplying the electric power moves up to a position B. Here, the shape memory alloy wire 112 can contract to a right side of the regulating member 114 at the position B, but the mobile object 111 is positioned at the position B by the regulating member 114.

Furthermore, the position of the mobile object 111 is controlled between the position A and the position B by comparing the resistance value of the shape memory alloy wire 112 with a command resistance value input from the command section 210. Here, the resistance value detected by the detecting section 130 decreases as the shape memory alloy wire 112 contracts. However, the regulating member 114 being at the position B, since the command resistance value may be set to right of the position B due to a variation in the resistance value, and since in this case, the resistance value does not reach the command resistance value due to the regulating member 114, the heating is continued incessantly resulting in an excessive heating.

Therefore, in the shape memory alloy actuator system 100 according to the embodiment, the minimum resistance value between the position A and the position B is acquired by calibration in advance, and when a command of the position B (minimum resistance value) is imparted, in the command correcting section 170, a correction is applied not to a resistance value corresponding to the position B but to the minimum resistance value which is acquired, and a command as a corrected command value is made. Consequently, instead of letting resistance values RA and RB corresponding to the positions A and B respectively as shown in FIG. 4 to be a range of the command resistance value, a correction in applied to the resistance value RB corresponding to the position B as in FIG. 5, and is let to be RB-α. In other words, the range of the command resistance value is regulated by the resistance value RA and the resistance value RB-α which is higher than the resistance value RB by an amount equivalent to a correction value α. Here, α is a positive number. At this time, the range of movement of the mobile object 111 is between a position C which coincides with the position A, and a position D which is toward the position A rather than the position B. By applying such correction to the command resistance value, it is possible to bring to a state of not abutting the position B, or in other words, a state in which no excessive heating occurs. Consequently, it is possible to maintain a position at which the control is carried out without excessive heating.

In the description made above, the correction is made by subtracting the correction value α from the resistance value corresponding to the position B. However, the correction is not restricted to such correction. For instance, an amount of correction may be calculated by a proportion corresponding to the resistance value between the positions A and B. When the calculation is made by the resistance value between the positions A and B, even when there occurs a variation in the length of the shape memory alloy wire 112 or a variation in an arrangement between the positions A and B, the position D is always at a desired proportional position from the position B which is specified. Moreover, a correction value depends on a detection sensitivity of the detecting section 130, and may be about 1% of a difference of the resistance value at the positions A and B.

It is desirable that the correction value α is higher than a detected-noise value. Concretely, it is preferable that the correction value is 10% or more of a stroke between the positions A and B. Here, the detected-noise value is not restricted to a noise value in the detection by the detecting section 130, and may include a noise value generated in the feedback circuit 120. When the correction value is set in such manner, even when there occurs to be a variation in the range of movement of the mobile object due to the noise detected, since the mobile object 111 does not reach the position B, it is possible to prevent the excessive heating.

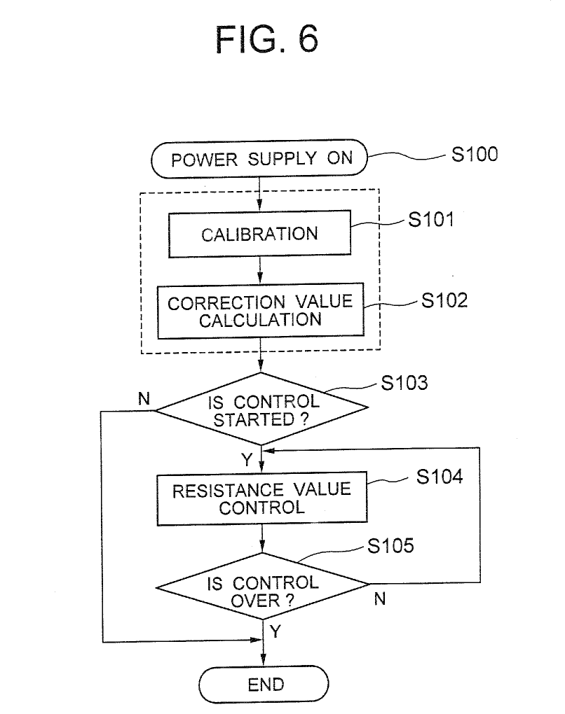

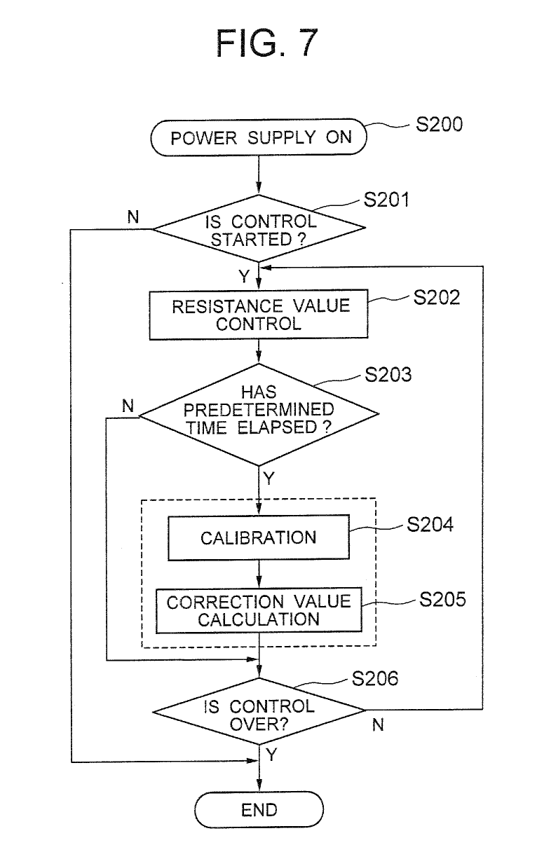

Next, a timing of calculating using the correction value, and the calibration in which the maximum resistance value and the minimum resistance value are acquired will be described by referring to FIG. 6 and FIG. 7. FIG. 6 is a flowchart showing a flow in a case of carrying out the calibration and the correction value calculation at the time of putting ON a power supply of the shape memory alloy actuator system 100, or in other words, before start of a control. FIG. 7 is a flow chart showing a flow in a case of carrying out the calibration and the correction value calculation at a predetermined time, after the power supply of the shape memory alloy actuator system 100 is put ON, or in other words, after start of the control.

Firstly, a flow of a process in the case of carrying out the calibration and the correction value calculation at the time when the power supply is put ON will be described below by referring to FIG. 6. In a case shown in FIG. 6, after the power supply is put ON (step S100), first of all, the calibration (step S101) and the correction value calculation (step S102) are carried out in order. Thereafter, the process shifts to a resistance value control of the shape memory alloy wire 112 (steps from step S103 to step S105).

When execution of the resistance value control has been selected (YES at step S103), after the resistance value control is carried out (step S104), a judgment of whether or not the control is to be terminated once again, is made (step S105). When execution of the control once again, is selected (NO at step S105), the resistance control is carried out once again (step S104). In this manner, whenever the resistance value control is carried out, a selection of whether or not the resistance value control is to be continued is made (step S105). When the termination of the control is selected (YES at step S105), the process ends.

Moreover, also in a case of carrying out the resistance value control by carrying out only the calibration and the correction value calculation (NO at step S103), the process is terminated.

Here, a result of the calibration (step S101) and the correction value calculation (step S102) is stored in the storage section 160. At the time of the subsequent power supply ON, the calibration and the correction value calculation are not carried out, and by using the result of calculation stored in the storage section 160, the resistance value control (steps from step S103 to step S105) is carried out. When the calibration and the correction value calculation are carried out in such manner at the time of putting the power supply ON, even when the power supply is put OFF once, at the time of carrying out the subsequent control, it is possible to carry out the control by referring to the resistance value at that point of time.

Whereas, the calibration and the correction value calculation may be carried out whenever the resistance value control is carried out. Accordingly, it is possible to carry out the control stably even when there is a secular change in the shape memory alloy wire 112.

Next, a flow of a process in a case of carrying out the calibration and the correction value calculation at every predetermined time interval after the power supply is put ON will be described below by referring to FIG. 7. In a case shown in FIG. 7, after the power supply is put ON (step S200), a selection of whether or not the resistance value control is to be carried out is made before carrying out the calibration and the correction value calculation (step S201).

When the selection of the resistance value control to be carried out is made (YES at step S201), a judgment of whether or not a predetermined time has elapsed after the start of the control is made (step S203) after the resistance value control is carried out (step S204). When the predetermined time has elapsed (YES at step S203), the calibration (step S204) and the correction value calculation (step S205) are carried out in order. A result of the calibration and the correction value calculation is stored in the storage section 160.

When the predetermined time has not elapsed at the step S203 (NO at step S203), and, after the calibration (step S204) and the correction value calculation (step S205) are carried out, a judgment of whether or not the control is to be terminated once again is made (step S206).

When a selection of the control to be carried out once again is made (NO at step S206), the resistance value control is carried out once again (step S204). Whenever such resistance value control is carried out, a judgment of whether or not a predetermined time has elapsed after the previous calibration and correction value calculation is made (step S203), and on elapsing of the predetermined time every time the calibration (step S204) and the correction value calculation (step S205) are carried out. Thereafter, when a selection of terminating the control is made (YES at step S206), the process ends. Here, the latest calibration result and correction value calculation result are stored in the storage section 160.

Moreover, even in a case of not carrying the resistance value control by carrying out only the calibration and the correction value calculation (NO at step S203), the process is terminated.

When the calibration and the correction value calculation are carried out after every predetermined interval in such manner, it is possible to cope with a change in characteristics of the shape memory alloy wire 112 in a case such as carrying out a continuous operation for a long time.

It is possible to set the predetermined time which is an interval for carrying out the calibration and the correction value calculation in FIG. 7, arbitrarily according to specifications and the other conditions of the shape memory alloy wire 112. Moreover, it is possible to carry out the calibration and the correction value calculation both at the time of putting ON the power supply of the shape memory alloy actuator 100 shown in FIG. 6 and after the start of the control shown in FIG. 7.

As it has been described above, the shape memory alloy actuator system according to the present invention is useful for a small-size equipment in which it is necessary to move a small-size mobile object accurately.

The shape memory alloy actuator system according to the present invention shows an effect that a resistance value in a range of movement determined by a regulating member before carrying out a resistance control is acquired, and a resistance value which can be commanded is calculated based on the resistance value acquired, and stored, and an arrangement is made such that no other resistance value is commanded. Accordingly, since it is possible to prevent the excessive heating o the shape memory alloy wire, it is possible to improve durability and to suppress the secular change, thereby making it possible to improve a stability and reliability.

What is claimed is:

1. A shape memory alloy actuator system comprising:
a shape memory alloy actuator in which, a range of movement of a mobile object attached to a shape memory alloy wire of which, a length elongates and contracts by a change in a temperature, is determined by a regulating member; and
a resistance feedback circuit, wherein
the resistance feedback circuit has a detecting section which detects a resistance of the shape memory alloy wire when the shape memory alloy actuator contracts and expands, a calculating section which compares an output signal acquired from the detecting section and a signal input by a command section, and calculates an applied electric current corresponding to the resistance value which is detected, an output section which outputs the applied electric current which is output from the calculating section, to the shape memory alloy actuator, a control section which controls at least the detecting section, the calculating section, and the output section, a storage section which stores a maximum value and a minimum value of the resistance which is measured in advance, and a command correcting section which corrects a signal output from the command section, based on the resistance value stored in the storage section, and
a command signal which is output from the command correcting section is set to a resistance value which is higher than the minimum resistance value by a correction value.

2. The shape memory alloy actuator system according to claim 1, wherein the correction value is higher than a detected-noise value.

3. The shape memory alloy actuator system according to 2, wherein the maximum resistance value and the minimum resistance value are acquired when a power supply is put ON.

4. The shape memory alloy actuator system according to claim 3, wherein the maximum resistance value and the minimum resistance value are acquired upon elapsing of a predetermined time.

5. The shape memory alloy actuator system according to claim 2, wherein the maximum resistance value and the minimum resistance value are acquired upon elapsing of a predetermined time.

6. The shape memory alloy actuator system according to claims 1, wherein the maximum resistance value and the minimum resistance value are acquired when a power supply is put ON.

7. The shape memory alloy actuator system according to claim 6, wherein the maximum resistance value and the minimum resistance value are acquired upon elapsing of a predetermined time.

8. The shape memory alloy actuator system according to claim 1, wherein the maximum resistance value and the minimum resistance value are acquired upon elapsing of a predetermined time.
